(19) United States
(12) Patent Application Publication
(10) Pub. No.: US 2010/0157578 A1
(43) Pub. Date: Jun. 24, 2010

(54) LIGHTING APPARATUS, DISPLAY APPARATUS AND TV RECEIVER

(76) Inventor: Yasumori Kuromizu, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/600,518

(22) PCT Filed: Jan. 22, 2008
(86) PCT No.: PCT/JP2008/050752

§ 371 Date: Nov. 17, 2009

(30) Foreign Application Priority Data
May 31, 2007 (JP) 2007-145382

(51) Int. Cl. G02F 1/13357

(52) U.S. Cl. 362/97.2; 362/97.1

(57) ABSTRACT

An apparatus comprising back chassis (4) covering the dorsal side of lighting apparatus (3); light sources (5) extending in one direction, disposed in parallel to the direction perpendicular to the direction of the extension, the light sources consisting of fluorescent tubes held by the back chassis (4); diffusion plate (7) disposed opposite to the light sources (5) so as to diffuse any light outgoing from the light sources (5); diffusion plate supporting pin (10) erected between mutually adjacent light sources (5) so as to support the diffusion plate (7); and protective member (11) consisting of a shock absorbing material capable of absorbing any shock by the elastic behavior thereof, disposed around the diffusion plate supporting pin (10).

### TECHNICAL FIELD

The present invention relates to a lighting apparatus that illuminates a display panel such as a liquid crystal panel, and to a display apparatus and a television receiver employing such a lighting apparatus.

### BACKGROUND ART

A conventional display apparatus is disclosed in Patent Document 1. FIG. 9 is a side sectional view schematically showing the display apparatus. The display apparatus 1 has a lighting apparatus 3 that faces a display panel 2. The lighting apparatus 3 is provided with a back chassis 4—formed of metal—, which is open at the display panel 2-side and covers the rear side of the lighting apparatus 3. Inside the back chassis 4, a plurality of light sources 5 comprising long-length fluorescent tubes are arranged side by side.

At the open side of the hack chassis 4, a diffusion plate 7 facing the light sources 5 is disposed. The diffusion plate 7 has its periphery held by the back chassis 4 and diffuses light emitted from the light sources 5 so as to make light for illuminating the display panel 2 uniform. In addition, the diffusion plate 7 is supported by diffusion-plate supporting pins 10 having a sharp point, which are fitted to the back chassis 4.

As the diffusion-plate supporting pins 10, a plurality of them are provided between the light sources 5 so that the diffusion plate 7 and the light sources 5 are kept apart. This prevents the light sources 5 reflected in display images, which is caused by the diffusion plate 7 being thermally deformed by the heat from the light sources 5 and coming closer to the light sources 5.

Patent Document 1: JP-A-2005-347005 (pages 4 to 9, FIG. 2)

### DISCLOSURE OF THE INVENTION

### Problems to be Solved by the Invention

According to the above-described conventional display apparatus 1, however, the light sources 5 may disadvantageously collide with the diffusion-plate supporting pins 10 and brake when shock acts on the display apparatus 1 during transportation etc. In particular, on arranging display screens vertically, when the light sources 5 extend horizontally and are arranged side by side in the vertical direction, the light sources 5 are likely to collide with the diffusion-plate supporting pins 10 due to deflection caused by their own weight.

An object of the present invention is to provide a lighting apparatus in which breakage of a light source can be prevented, and to provide a display apparatus and a television receiver that employ such a lighting apparatus.

### Means for Solving the Problem

To achieve the above object, according to the present invention, a lighting apparatus comprises: a back chassis covering the rear side of the lighting apparatus; a light source comprising a fluorescent tube held on the back chassis, the fluorescent tube having parts extending in one direction arranged side by side in a direction perpendicular to the direction of extension; a diffusion plate arranged to face the light source to diffuse light emitted from the light source; a diffusion-plate supporting pin arranged upright between adjacent parts of the light source to support the diffusion plate; and a protective member arranged around the diffusion-plate supporting pin and formed of a shock absorbing material absorbing shock by elasticity.

With this arrangement, the back chassis covers the rear side of the lighting apparatus and holds the light source comprising a fluorescent tube. The light source comprising a plurality of fluorescent tubes or a meandering fluorescent tube that, preferably, has parts extending horizontally to be arranged side by side in the vertical direction. Between adjacent parts of the light source, the diffusion-plate supporting pin that is fitted to the back chassis is arranged, and the diffusion plate facing the light source makes contact with the diffusion-plate supporting pin to be supported thereby. By application of a voltage, light emitted from the light source is diffused by the diffusion plate and illuminates a display panel that faces the diffusion plate. The diffusion-plate supporting pin is provided with the protective member that covers around it. The protective member is formed of a shock absorbing material such as resin or rubber, and absorbs shock when the light source collides with it.

Moreover, in the lighting apparatus arranged as described above, a projection is provided on the circumferential surface of the diffusion-plate supporting pin, and the protective member through which the diffusion-plate supporting pin is inserted has its diffusion plate-side locked by the projection. With this arrangement, the tubular protective member is put on the diffusion-plate supporting pin from its tip. Passing the projection, the protective member is arranged on the base side of the projection, and has its diffusion plate-side locked by the projection so that it does not come off.

According to the invention, in the lighting apparatus arranged as described above, the outer circumference surface of the diffusion-plate supporting pin is formed to have a taper shape, and the inner circumference surface of the protective member through which the diffusion-plate supporting pin is inserted is formed to have a taper shape.

Moreover, according to the invention, in the lighting apparatus arranged as described above, a concave part and a convex part are formed at the outer circumference surface of the protective member through which the diffusion-plate supporting pin is inserted.

Moreover, according to the invention, in the lighting apparatus arranged as described above, parts of the light source extend in the horizontal direction arranged side by side in the vertical direction.

Moreover, according to the invention, in the lighting apparatus arranged as described above, the protective member is formed to be transparent, white/whitish, or gray/grayish.

Moreover, according to the invention, in the lighting apparatus arranged as described above, the protective member is formed of microcell polymer. With this arrangement, the protective member is formed of microcell polymer, which is a shock absorbing material such as PORON (manufactured by Rogers Inoac Corporation).

Moreover, according to the invention, in the lighting apparatus arranged as described above, the protective member is fowled of foamed polyethylene.

Moreover, according to the invention, in the lighting apparatus arranged as described above, the protective member is formed of rubber sponge.

Moreover, according to the invention, in the lighting apparatus arranged as described above, the protective member is formed of silicon-based gel.

Moreover, the display apparatus according to the invention comprises the lighting apparatus arranged as described above and the display panel that faces the diffusion plate.

Moreover, according to the invention, in the display apparatus arranged as described above, the display panel is built with a liquid crystal panel having a pair of substrates with liquid crystal sealed in between.

Moreover, a television receiver according to the invention comprises the display apparatus arranged as described above.

### ADVANTAGES OF THE INVENTION

According to the present invention, the protective member arranged around the diffusion-plate supporting pin that supports the diffusion plate is formed of a shock absorbing material; thus, it is possible to prevent breakage of the light source caused by the light source colliding with the diffusion-plate supporting pin when shock acts on the lighting apparatus.

According to the invention, the protective member through which the diffusion-plate supporting pin is inserted is locked by the projection provided on the circumference surface of the diffusion-plate supporting pin; thus, the protective member can be easily prevented from coming off.

According to the invention, the outer circumferential surface of the diffusion-plate supporting pin and the inner circumferential surface of the protective member are formed to have a taper shape; thus, the protective member can be positioned easily in the height direction. Moreover, the area increases where the diffusion-plate supporting pin is in contact with the protective member, and, by friction, the protective member can be easily prevented from coming off.

Moreover, according to the invention, a concave part and a convex part are formed at the outer circumferential surface of the protective member, making it easy to hold the protective member with fingers. Accordingly, it is possible to improve workability when putting the protective member on the diffusion-plate supporting pin.

Moreover, according to the invention, even though the light source is likely to collide with the diffusion-plate supporting pin due to its own weight, since parts of the light source extend in the horizontal direction arranged side by side in the vertical direction, it is possible to surely prevent breakage of the light source caused by collision.

Moreover, according to the invention, the protective member is formed to be transparent, white/whitish, or gray/grayish; thus, it is possible to prevent degraded image quality caused by the protective member reflected in the display panel.

Moreover, according to the invention, the protective member is formed of microcell polymer; thus, it is possible to easily realize a protective member absorbing shock.

Moreover, according to the invention, the protective member is formed of foamed polyethylene; thus, it is possible to easily realize a protective member absorbing shock.

Moreover, according to the invention, the protective member is formed of rubber sponge; thus, it is possible to easily realize a protective member absorbing shock.

Moreover, according to the invention, the protective member is formed of silicon-based gel; thus, it is possible to easily realize a protective member absorbing shock.

### BRIEF DESCRIPTION OF DRAWINGS

FIG. 1 A side sectional view showing a display apparatus embodying the present invention;

FIG. 2 A plan view showing how light sources of the display apparatus embodying the invention are supported;

FIG. 3 A perspective view showing a protective member of the display apparatus embodying the invention;

FIG. 4 A perspective view showing another protective member of the display apparatus embodying the invention;

FIG. 5 A plan view showing another protective member of the display apparatus embodying the invention;

FIG. 6 A plan view showing another protective member of the display apparatus embodying the invention;

FIG. 7 A diagram showing another diffusion-plate supporting pin of the display apparatus embodying the invention;

FIG. 8 A diagram showing another diffusion-plate supporting pin of the display apparatus embodying the invention; and

FIG. 9 A side sectional view showing a conventional display apparatus.

### LIST OF REFERENCE SYMBOLS

1 display apparatus
2 display panel
3 lighting apparatus
4 back chassis
5 light source
6 supporting member
7 diffusion plate
8 optical sheet
9 connecting portion
10 diffusion-plate supporting pin
10a projection
11 protective member

### BEST MODE FOR CARRYING OUT THE INVENTION

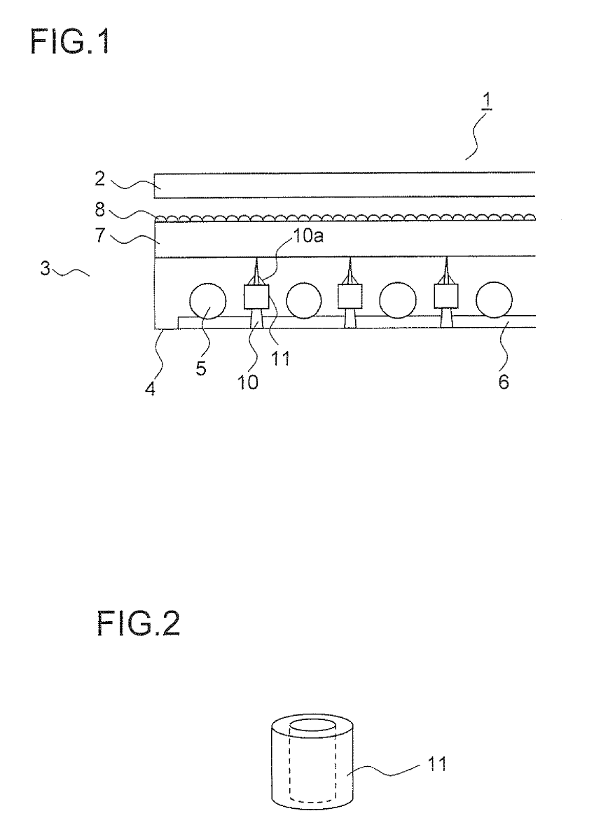

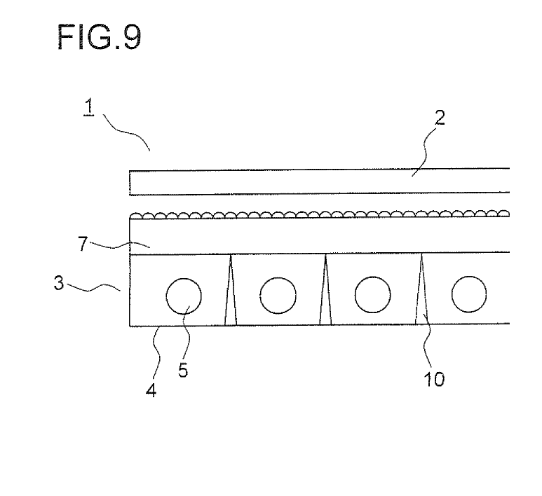

Hereinafter, an embodiment of the present invention will be described with reference to the accompanying drawings. For convenience of description, such parts as find their counterparts in the above-mentioned conventional example shown in FIG. 9 are identified by common reference signs. FIG. 1 is a side sectional view showing a display apparatus according to one embodiment. A display apparatus 1, such as a television receiver or a display, has a lighting apparatus 3 arranged at the back of a display panel 2. The display panel 2 is built with a liquid crystal panel or the like that has a pair of substrates with liquid crystal sealed in between. The display panel 2 has pixels arranged in a matrix, and light emitted from the lighting apparatus 3 transmits a predetermined pixel of the display panel 2 so that images are displayed.

The lighting apparatus 3 is provided with a back chassis 4—formed of metal—, which is open at its front and covers the rear side of the lighting apparatus 3. By forming the back chassis 4 with metal, it is possible to obtain a desired strength with a decreased thickness thereof, and thus to achieve a compact lighting apparatus 3. Inside the back chassis 4, a light source 5 is disposed. The light source 5 comprises a plurality of cylindrical fluorescent tubes having parts extending in one direction arranged at a predetermined interval (period) in the direction perpendicular to the direction of extension. The light source 5 may be arranged side by side at a predetermined interval by composing them with one or more meandering fluorescent tubes.

At the open side of the back chassis 4, a diffusion plate 7 that faces the light source 5 is disposed. The diffusion plate 7 is formed of a plate-like transmissive member holding a diffusion member, and diffuses light emitted from the light source 5. The diffusion plate 7 has its peripheral portion held by the back chassis 4, and is supported by a diffusion-plate supporting pin 10 fitted to the back chassis 4.

The diffusion-plate supporting pin 10 is formed out of a conical resin component having a sharp point, and is fitted to, with a claw portion (unillustrated) at its back engaged with, the back chassis 4. As the diffusion-plate supporting pin 10, a plurality of them are provided between parts of the light source 5 having a plurality of fluorescent tubes or a meandering fluorescent tube arranged side by side, so that the diffusion plate 7 and the light source 5 are kept apart. In this way, it is possible to prevent the light source 5 reflected in display images, which is caused by the diffusion plate 7 being thermally deformed by the heat from the light source 5 and coming close to the light source 5.

Around the diffusion-plate supporting pin 10, a protective member 11 is arranged. FIG. 2 is a perspective view showing the protective member 11. The protective member 11 is formed into a tubular shape and, as described in detail below, is formed of a shock-absorbing material absorbing shock by elasticity.

On the circumferential surface of the diffusion-plate supporting pin 10, a projection 10a that projects in the radius direction is provided. The tubular protective member 11 is put on the diffusion-plate supporting pin 10 from its tip past the projection 10a, to be arranged on the base side of the projection 10a. In this way, the protective member 11 is locked at its diffusion plate 7-side by the projection 10a, so that it does not come off.

On the diffusion plate 7, an optical sheet 8 such as a prism sheet or a lens sheet is arranged. The optical sheet 8 focuses light emitted from the diffusion plate 7 in a range of a predetermined view angle.

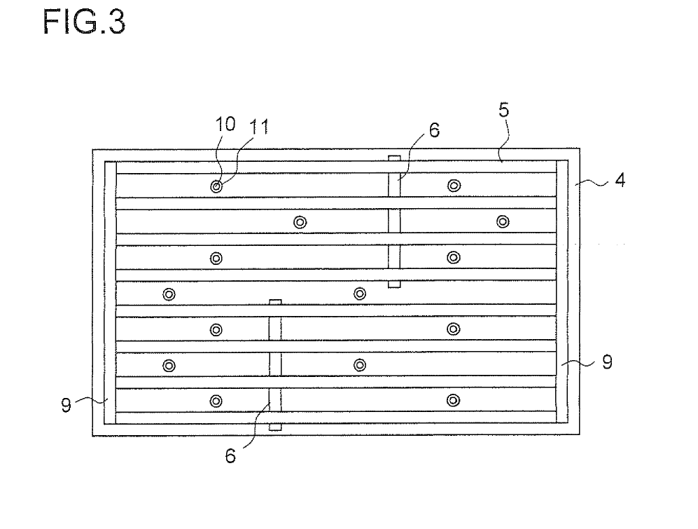

FIG. 3 is a plan view showing how the light source 5 is supported inside the back chassis 4. At opposite side portions of the back chassis 4, connecting portions 9 that hold opposite end portions of the light source 5 to feed electric power to it are arranged. By the connecting portions 9, the light source 5 is held in the back chassis 4. In addition, the back chassis 4 has supporting members 6 laid in it, and on the supporting members 6, the light source 5 is placed. The supporting members 6 are formed of a shock-absorbing material absorbing shock by elasticity.

For the supporting members 6 and the protective member 11, it is possible to use resin, rubber, or the like that is spongy or has cushioning properties. Preferably, for the supporting members 6 and the protective member 11, it is possible to use foamed polyethylene, rubber sponge, silicon-based gel, or the like. Further preferably, for the supporting members 6 and the protective member 11, microcell polymer (for example, PORON manufactured by Rogers Inoac Corporation) is used, since it offers a high shock-absorbing performance.

The supporting members 6 and the protective member 11 are formed to be transparent, white/whitish, or gray/grayish. In this way, it is possible to prevent degraded image quality caused by the supporting members 6 and the protective member 11 reflected in the display panel 2. Note that white/whitish include not only white but also pale yellow etc.; gray/grayish include pale gray and dark gray.

The light source 5 is connected to the connecting portions 9 with the light source 5 pressing the supporting members 6 and the supporting members 6 being contracted. As a result, parts of the light source 5 each has part of a circumferential surface thereof, which is smaller than half the circumference thereof, in contact with the supporting members 6, and thus the light source 5 has its part between the opposite end portions supported by the supporting members 6.

Consequently, movement of the light source 5 towards the back chassis 4 is prevented by the elastic behavior of the supporting members 6, and that towards the adjacent light source 5 is prevented by the frictional force of the supporting members 6. Moreover, when shock acts on the display apparatus 1, the shock force is absorbed by the supporting members 6. It is therefore possible to prevent deflection of the light source 5 caused by its own weight, and to prevent breakage of the light source 5 caused by its colliding with the back chassis 4 due to shock etc. during transportation.

Moreover, the light source 5 is supported by the supporting members 6 with smaller contact area. Thus, the amount of heat dissipated from the light source 5 via the supporting members 6 is reduced, and a drop in brightness in parts of the light source in contact with the supporting members 6 can be prevented. This makes it possible to illuminate the display panel 2 with uniform brightness, and thus to achieve satisfactory display images. The supporting members 6 may support a plurality of parts of the light source 5, or one place in a center part of the light source 5.

In the display apparatus 1 arranged as described above, light emitted from the light source 5 enters the diffusion plate 7. The light incident on the diffusion plate 7 is diffused, and the light so diffused enters the optical sheet 8. The light incident on the optical sheet 8 has its advancing direction adjusted to be in a desired range of view angle, and irradiates the display panel 2. This makes images on the display panel 2 viewable.

According to the embodiment, the protective member 11 arranged around the diffusion-plate supporting pin 10 that supports the diffusion plate 7 is formed of a shock-absorbing material; thus, it is possible to prevent breakage of the light source 5 caused by its colliding with the diffusion-plate supporting pin 10 when shock acts on the lighting apparatus 3.

When parts of the light source 5 are each regarded as a simple beam, the maximum amount of deflection δ (mm) of a part (of the light source 5) is expressed by formula (1). M (g) represents the mass of the part (of the light source 5), α (m/s²) represents the acceleration acting on the part (of the light source 5), l (mm) represents the length of the part (of the light source 5), and E (GPa) represents Young's modulus. In addition, I (m⁴) represents the second moment of area of the part (of the light source 5) and, suppose the part (of the light source 5) is a hollow rod with an inside diameter and an outside diameter of a (mm) and b (mm), respectively, I (m⁴) is then expressed by formula (2).

δ=5Mαl³/(384EI) (1)

I=(b⁴−a⁴)/64 (2)

Accordingly, the protective member 11 may be provided when the amount of deflection δ due to the acceleration a caused by shock acting on the lighting apparatus 3 is larger than the distance between parts of the light source 5 and the diffusion-plate supporting pin 10.

When the display apparatus 1 is arranged such that a display screen is vertical, parts of the light source 5 extend in the horizontal direction arranged side by side in the vertical direction. Thus, when the light source 5 deflects due to its own weight, it is likely to collide with the diffusion-plate supporting pins 10. However, thanks to the provision of the protective member 11, breakage of the light source 5 can be surely prevented. Note that the amount of deflection δ of the light source 5 due to its own weight can be obtained by substituting the acceleration of gravity g (m/s²) for the acceleration α in formula (1).

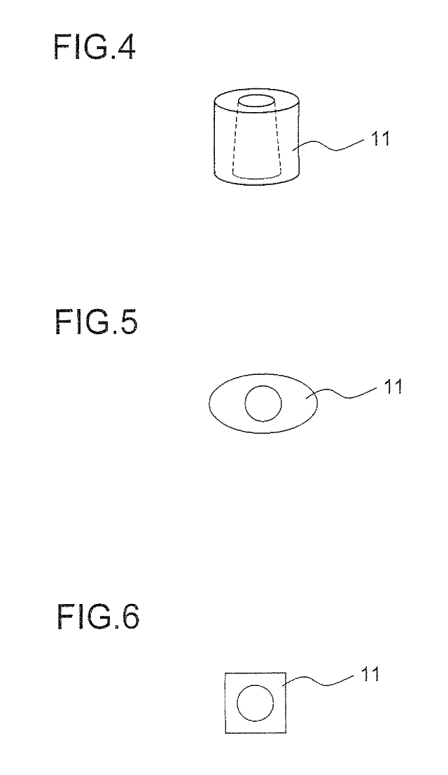

In the embodiment, the protective member 11 or the diffusion-plate supporting pin 10 may have other shapes. For example, as shown in FIG. 4, the inner circumferential surface of the tubular protective member 11 may be foamed to have a taper shape that matches the outer circumferential surface of the diffusion-plate supporting pin 10. This makes it possible for the protective member 11 to be positioned in the height direction easily. In addition, the area increases where the diffusion-plate supporting pin 10 is in contact with the protective member 11, and, by friction, it is possible to easily prevent the protective member 11 from coming off. Moreover, as shown in plan views of FIGS. 5 and 6, the protective member 11 may have an elliptic or a rectangular sectional shape.

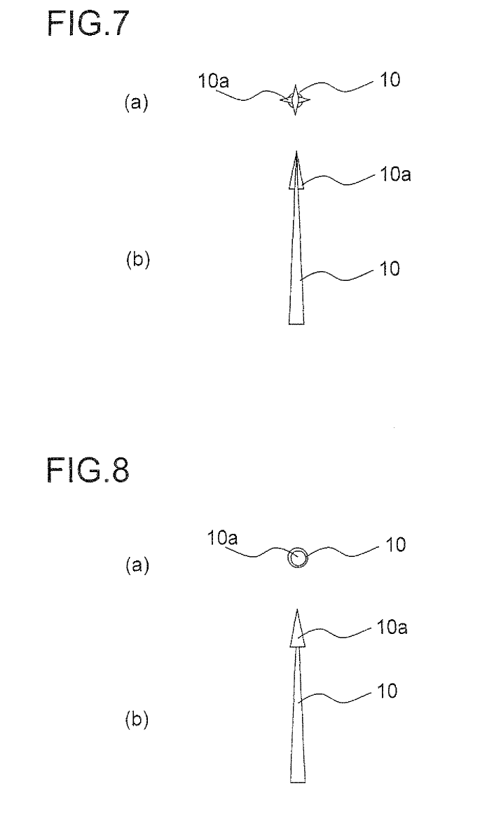

Moreover, as shown in FIG. 7, an arrow-headed projection 10a may be formed at the tip of the diffusion-plate supporting pin 10. As shown in FIG. 8, a conical projection 10a may be formed at the tip of the diffusion-plate supporting pin 10. Note that in. FIGS. 7 and 8, (a) is a plan view and (b) is a side view.

### INDUSTRIAL APPLICABILITY

The present invention can be used in lighting apparatuses that illuminate display panels such as liquid crystal panels, and in display apparatuses such as television receivers and displays that employ such lighting apparatuses.

1. A lighting apparatus comprising:
a back chassis covering a rear side;
a light source comprising a fluorescent tube held on the back chassis, the fluorescent tube having parts extending in one direction arranged side by side in a direction perpendicular to a direction of extension;
a diffusion plate arranged to face the light source to diffuse light emitted from the light source;
a diffusion-plate supporting pin arranged upright between adjacent parts of the light source to support the diffusion plate; and
a protective member arranged around the diffusion-plate supporting pin and formed of a shock absorbing material absorbing shock by elasticity.

2. The lighting apparatus according to claim 1,
wherein a projection is provided on a circumferential surface of the diffusion-plate supporting pin, and the protective member through which the diffusion-plate supporting pin is inserted has a diffusion plate-side thereof locked by the projection.

3. The lighting apparatus according to claim 1,
wherein an outer circumferential surface of the diffusion-plate supporting pin is formed to have a taper shape, and an inner circumferential surface of the protective member through which the diffusion-plate supporting pin is inserted is formed to have a taper shape.

4. The lighting apparatus according to claim 1,
wherein a concave part and a convex part are formed at an outer circumferential surface of the protective member through which the diffusion-plate supporting pin is inserted.

5. The lighting apparatus according to claim 1,
wherein parts of the light source extend in a horizontal direction arranged side by side in a vertical direction.

6. The lighting apparatus according to claim 1,
wherein the protective member is formed to be transparent, white/whitish, or gray/grayish.

7. The lighting apparatus according to claim 1,
wherein the protective member is formed of microcell polymer.

8. The lighting apparatus according to claim 1,
wherein the protective member is formed of foamed polyethylene.

9. The lighting apparatus according to claim 1,
wherein the protective member is formed of rubber sponge.

10. The lighting apparatus according to claim 1,
wherein the protective member is formed of silicon-based gel.

11. A display apparatus comprising:
the lighting apparatus according to claim 1; and
a display panel facing the diffusion plate.

12. The display apparatus according to claim 11,
wherein the display panel is built with a liquid crystal panel having a pair of substrates with liquid crystal sealed in between.

13. A television receiver comprising the display apparatus according to claim 11.
